(19) United States
(12) Patent Application Publication
(10) Pub. No.: US 2016/0086492 A1
(43) Pub. Date: Mar. 24, 2016

(54) APPARATUS AND METHOD FOR CALCULATING REFERENCE ROUTE OF MOVING OBJECT

(71) Applicant: SAMSUNG SDS CO., LTD., Seoul (KR)

(72) Inventors: Sungil KIM, Seoul (KR); Sung Woo LEE, Seongnam-si (KR); Inhyok CHA, Seoul (KR)

(73) Assignee: SAMSUNG SDS CO., LTD., Seoul (KR)

(21) Appl. No.: 14/584,551

(22) Filed: Dec. 29, 2014

(30) Foreign Application Priority Data
Sep. 24, 2014 (KR) 10-2014-0127859

(51) Int. Cl. G08G 5/00

(52) U.S. Cl. CPC G08G 5/0017

(57) ABSTRACT

Disclosed are an apparatus and method for calculating a reference route of a moving object. The apparatus for calculating a reference route of a moving object includes a region divider configured to divide a region including an origin and a destination of the moving object into a plurality of cells; a data mapper configured to map position data of the moving object to the plurality of cells; a main cell selector configured to select one or more main cells from among the plurality of cells according to number of pieces of the position data that are mapped to the respective plurality of cells; and a reference route calculator configured to form the reference route of the moving object by sequentially connecting the origin, the one or more main cells, and the destination.

### CROSS-REFERENCE TO RELATED APPLICATION

This application claims priority from Korean Patent Application No. 10-2014-0127859, filed on Sep. 24, 2014, the disclosure of which is incorporated herein by reference in its entirety.

### BACKGROUND

1. Field

The present disclosure relates to a technique for calculating a reference route and a reference moving time of a moving object from previous position tracking data.

2. Discussion of Related Art

Early or real time detection of abnormal situations is one of core techniques for reducing cost and managing risk in various transportation scenarios. For example, in fourth-party logistics (4PL), accurate prediction of logistical delays is essential in reducing response costs and satisfying customers. Thus, 4PL providers are making efforts to secure visibility of logistics by introducing techniques for tracking a position of a vessel or aircraft in real time. However, even when a position of a moving object such as a vessel or aircraft is found in real time, accurate analysis cannot be performed unless there is a reference value for determining whether a delay has occurred.

Conventionally, a user selects a case that is determined to be best, and uses the case as a reference line to determine whether a moving object is delayed. However, since such an artificial method entirely depends on a user's subjective decision, the result may vary depending on which case is selected.

### SUMMARY

The present disclosure is directed to a means for calculating a reference moving route and a reference moving time of a moving object based on previous case data.

According to an aspect of the present disclosure, there is provided an apparatus for calculating a reference route of a moving object, the apparatus including: a region divider configured to divide a region including an origin and a destination of the moving object into a plurality of cells; a data mapper configured to map previous position tracking data of the moving object to the plurality of cells; a main cell selector configured to select one or more main cells from among the plurality of cells according to the number of pieces of the previous position tracking data that are mapped to the respective plurality of cells; and a reference route calculator configured to form the reference route of the moving object by sequentially connecting the origin, the one or more main cells, and the destination.

The data mapper may select position tracking data corresponding to a case in which the moving object arrives at the destination in a preset normal time range from among the previous position tracking data to map the selected position tracking data to the plurality of cells.

The main cell selector may select, as the main cells, a cell for which the number of pieces of the mapped previous position tracking data is equal to or greater than a preset reference value.

The reference route calculator may calculate a partial moving route of the moving object in each section between two adjacent main cells and combine the partial moving routes calculated for each section to form a reference moving route of the moving object.

The reference route calculator may form a rectangular partial region including two adjacent main cells, designate the two main cells as an origin cell and a destination cell, generate one or more moving candidate routes connecting the origin cell and the destination cell in the partial region, and determine, as the partial moving route of the moving object between the two adjacent main cells, a moving candidate route having a largest number of pieces of the previous position tracking data that are mapped to the respective moving candidate routes.

The moving candidate route may be generated by sequentially moving between adjacent cells in the partial region in a direction from the origin cell to the destination cell.

The reference route calculator may calculate a partial moving distance of the moving object in a section between two adjacent main cells and add the partial moving distances calculated for each section to calculate a reference moving distance of the moving object.

The reference route calculator may calculate the partial moving distance according to the number of cells included in the partial moving route of the moving object when cells included in the partial region have the same size.

The reference route calculator may calculate the partial moving distance by adding a horizontal length and a vertical length of the partial region when cells included in the partial region have different sizes.

The apparatus may further include a reference moving time calculator configured to calculate a reference moving time of the moving object in the reference route using the previous position tracking data.

The reference moving time calculator may calculate a reference moving time of each main cell using time information included in the previous position tracking data that is mapped to the main cells and calculate a reference moving time of each cell on a moving route that connects the main cells based on the reference moving time of each of the main cells.

The reference moving time of each main cell may be any one of an average value and a median value of time information of the previous position tracking data that is mapped to the main cell.

The reference moving time of each cell on the moving route that connects the main cells may be calculated by equally dividing a moving time difference between adjacent main cells by the number of cells on a moving route that connects the main cells.

According to another aspect of the present disclosure, there is provided a method of calculating a reference route of a moving object, the method including: dividing a region including an origin and a destination of the moving object into a plurality of cells; mapping previous position tracking data of the moving object to the plurality of cells; selecting one or more main cells from among the plurality of cells according to the number of pieces of the previous position tracking data that are mapped to the respective plurality of cells; and forming the reference route of the moving object by sequentially connecting the origin, the one or more main cells, and the destination.

The mapping may include selecting position tracking data corresponding to a case in which the moving object arrives at the destination in a preset normal time range from among the previous position tracking data to map the selected position tracking data to the plurality of cells.

The selecting of the one or more main cells may include selecting, as the main cells, a cell for which the number of pieces of the mapped previous position tracking data is equal to or greater than a preset reference value.

The forming of the reference route may further include: calculating a partial moving route of the moving object in a section between two adjacent main cells; and combining the partial moving routes calculated for each section to form a reference moving route of the moving object.

The calculating of the partial moving route of the moving object may further include: forming a rectangular partial region including two adjacent main cells and designating the two main cells as an origin cell and a destination cell; generating one or more moving candidate routes connecting the origin cell and the destination cell in the partial region; calculating the number of pieces of the previous position tracking data that are mapped to cells included in each of the moving candidate routes; and determining, as the partial moving route of the moving object between the two adjacent main cells, a moving candidate route having a largest number of pieces of the previous position tracking data.

The moving candidate route may be generated by sequentially moving adjacent cells in the partial region in a direction from the origin cell to the destination cell.

The forming of the reference route may further include: calculating a partial moving distance of the moving object in a section between two adjacent main cells; and adding the partial moving distances calculated for each section to calculate a reference moving distance of the moving object.

The calculating of the partial moving distance of the moving object may include calculating the partial moving distance according to the number of cells included in the partial moving route of the moving object when cells included in the partial region have the same size.

The calculating of the partial moving distance of the moving object may include calculating the partial moving distance by adding a horizontal length and a vertical length of the partial region when cells included in the partial region have different sizes.

The method may further include, after forming the reference route of the moving object, calculating a reference moving time of the moving object in the reference route using the previous position tracking data.

The calculating of the reference moving time may further include:
calculating a reference moving time of each main cell using time information included in the previous position tracking data that is mapped to the main cells; and calculating a reference moving time for each cell on a moving route that connects the main cells based on the reference moving time of each of the main cells.

The reference moving time of each main cell may be any one of an average value and a median value of time information of the previous position tracking data that is mapped to the main cell.

The reference moving time of each cell on the moving route that connects the main cells may be calculated by equally dividing a moving time difference between adjacent main cells by the number of cells on a moving route that connects the main cells.

According to still another aspect of the present disclosure, there is provided a computer program stored in a storage medium to execute the method in combination with hardware.

An embodiment of present disclosure provides an apparatus for calculating a reference route of a moving object featuring at least a region divider which divides a region including an origin and a destination of the moving object into a plurality of cells; a data mapper which maps previous position tracking data of the moving object to the plurality of cells; a main cell selector which selects one or more main cells from among the plurality of cells according to a number of pieces of the previous position tracking data that are mapped to the respective plurality of cells; and a reference route calculator which forms the reference route of the moving object by sequentially connecting the origin, the one or more main cells, and the destination.

### BRIEF DESCRIPTION OF THE DRAWINGS

The above and other objects and features of the present disclosure will become more apparent to those of ordinary skill in the art by describing in detail exemplary embodiments thereof with reference to the accompanying drawings, in which:

FIG. 1 is a block diagram illustrating an apparatus for calculating a reference route of a moving object according to an embodiment of the present disclosure;

FIG. 2 is an exemplary diagram illustrating previous position tracking data of a moving object according to an embodiment of the present disclosure;

FIG. 3 is an exemplary diagram illustrating a cell-based data distribution in section 1 among the previous position tracking data that is shown in FIG. 2;

FIG. 4 is an exemplary diagram illustrating a partial rectangular region that is formed by two adjacent main cells in section 1 shown in FIG. 3;

FIG. 5 is an exemplary diagram illustrating a reference moving route in section 1 that is generated by a reference route calculator according to an embodiment of the present disclosure;

FIG. 6 is an exemplary diagram illustrating a reference moving route in section 2 that is generated by a reference route calculator according to an embodiment of the present disclosure;

FIG. 7 is an exemplary diagram illustrating a rectangular section that is formed by two main cells when the two main cells have different sizes according to an embodiment of the present disclosure; and

FIG. 8 is a flowchart illustrating a method of calculating a reference route of a moving object according to an embodiment of the present disclosure.

### DETAILED DESCRIPTION OF EXEMPLARY EMBODIMENTS

Hereinafter, exemplary embodiments of the present disclosure will be described in detail with reference to the accompanying drawings. The following detailed description is provided for better understanding of a method, an apparatus, and/or a system that are disclosed in this specification. However, this is merely exemplary, and the present disclosure is not limited thereto.

In describing embodiments of the present disclosure, when it is determined that detailed description of known techniques associated with the present disclosure would unnecessarily obscure the gist of the present disclosure, the detailed description thereof will be omitted. Also, the terms described below are defined in consideration of the functions in the present disclosure, and thus may vary depending on a user, intention of an operator, or custom. Accordingly, the terms will be defined based on the whole specification. The terminology used herein is for the purpose of only describing embodiments of the present disclosure, and should not be restrictive. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

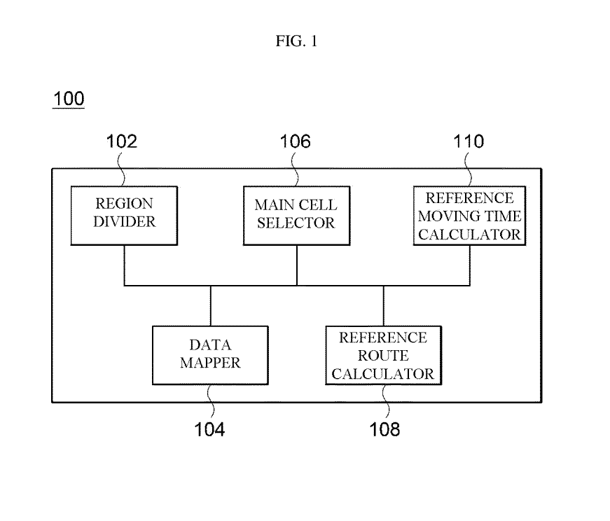

FIG. 1 is a block diagram illustrating an apparatus 100 for calculating a reference route of a moving object according to an embodiment of the present disclosure. The apparatus 100 for calculating a reference route of a moving object according to an embodiment of the present disclosure denotes an apparatus for calculating a reference route that is used to determine whether a moving object is in a normal operation using previous operation data of the moving object such as a vehicle, a vessel, and an aircraft and a reference moving time along the reference route. As shown in FIG. 1, the apparatus 100 for calculating a reference route of a moving object according to an embodiment of the present disclosure includes a region divider 102, a data mapper 104, a main cell selector 106, and a reference route calculator 108, and may further include a reference moving time calculator 110. In an exemplary embodiment, one or more of the region divider, the data mapper, the main cell selector and the reference route calculator are implemented via CPU or hardware processor.

The region divider 102 divides a region including an origin and a destination of a moving object into a plurality of cells. As an embodiment, the cell may have a rectangular shape having a certain size. For example, the region divider 102 may set the region to include rectangles each having a width of one degree and a length of one degree. As such, when the size of the cell is determined in degrees (°) of latitude and longitude, a cell to which the moving object belongs is directly found by using the latitude and longitude in position data of the moving object. However, embodiments of the present disclosure are not limited to a cell having a specific size or shape. The size of the cell may be determined appropriately in consideration of the size of the region. For example, the region divider 102 may set each cell to have a rectangular shape with a width of 1/N degrees and a length of 1/N degrees. This is particularly useful when estimating a short route (that is, when an entire moving distance is less than one degree (°) in width or length). In addition, according to an embodiment, a region divider 102 may divide the entire route into several sub-routes and use cells having different sizes for each sub-route. In this case, the sizes of the sub-routes and the sizes of the cells to be utilized for each sub-route may be selected appropriately in consideration of several factors such as an operational environment or a positioning frequency of the moving object.

In an embodiment, the plurality of cells may be set to have the same size. If the cells are uniform in size, calculation such as the Euclidean distance is not necessary to calculate a distance between points. This is because the distance between cells may be simply calculated by counting the number of cells between two cells. In another embodiment, the plurality of cells may be set to have different sizes. For example, the region divider 102 may preset and use some types of cells with sizes that are multiples of each other. In this case, a distance between two points may be calculated according to the types and number of cells that may connect the two points.

Next, the data mapper 104 maps previous position tracking data, e.g. position data or position tracking data, of the moving object to the plurality of cells. That is, the data mapper 104 performs dimension reduction from bivariate position information of a moving object that includes latitude and longitude to a univariate cell unit.

In an embodiment, the previous position tracking data may be previous operation case data of the moving object or another moving object that moves along the same route as the moving object. The previous position tracking data may be stored in a storage region of the data mapper 104 or may be stored and managed in a separate database (not shown) depending on embodiments. In addition, the data mapper 104 may be configured to map only cases in which an operation delay has not occurred, that is, cases in which the moving object departed from an origin in a preset normal time range and arrived at a destination in a normal time range, to the plurality of cells. In an embodiment, the storage region or separate database comprises a computer memory (RAM, ROM, etc.) or the like. In a further embodiment, the various elements of apparatus 100 are implemented via a CPU, hardware processor, or other computing device including further electronic hardware.

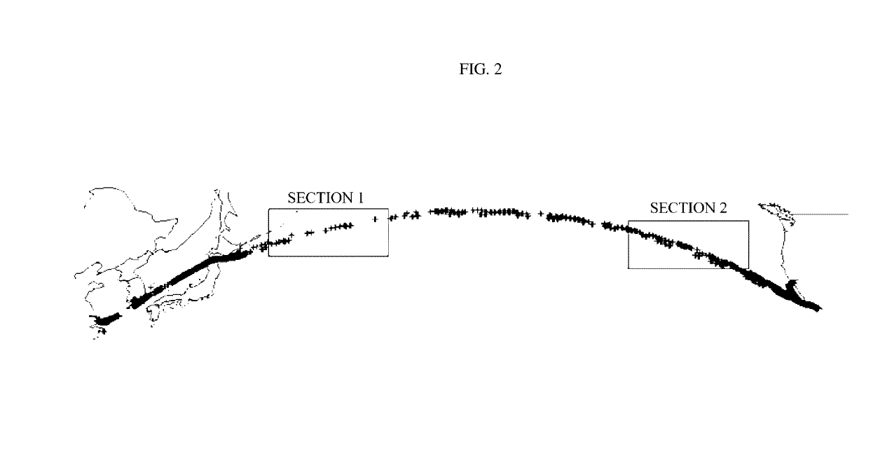

FIG. 2 is an exemplary diagram illustrating previous position tracking data of a moving object according to an embodiment of the present disclosure. In an embodiment shown in FIG. 2, a plurality of positions of the previous position tracking data for a specific operation are displayed on a map, and several cases are displayed to overlap each other on one map.

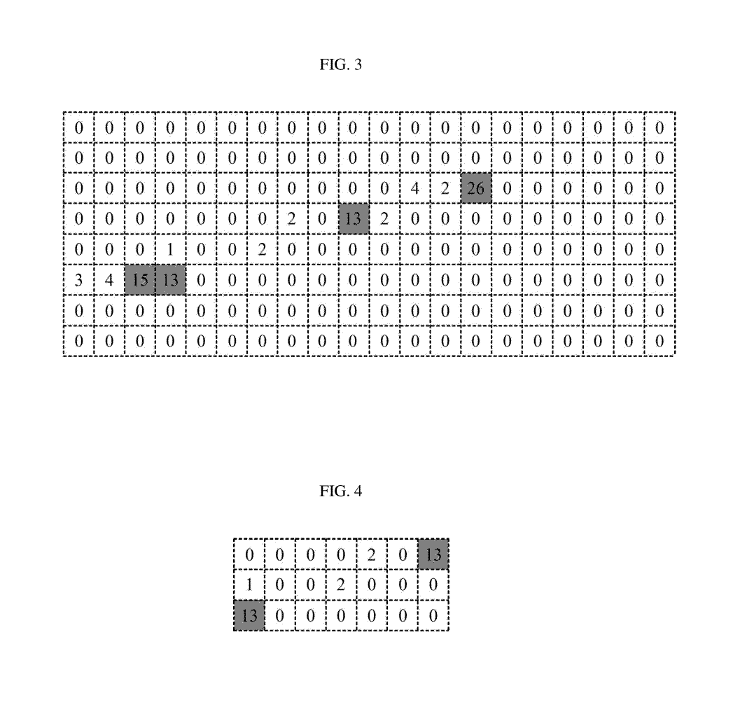

FIG. 3 is an exemplary diagram illustrating a cell-based data distribution in section 1 among the previous location tracking data that is shown in FIG. 2. As shown in FIG. 3, section 1 consists of a total of 160 rectangular cells, that is, 20 in width and 8 in height, and includes a total of 89 pieces of position tracking data. For example, in section 1, a value of a cell that is positioned in a sixth row from the top and a first column (hereinafter denoted as (6, 1)) is 3, which denotes that the number of pieces of the previous position tracking data having position information corresponding to the cell is 3.

The main cell selector 106 selects one or more main cells from among the plurality of cells according to a number of pieces of the previous position tracking data that are mapped to the respective plurality of cells. In an embodiment, the main cell selector 106 may select, as the main cells, a cell having the number of pieces of the mapped previous position tracking data equal to or greater than a preset reference value. For example, the main cell selector 106 may select, as the main cells, a cell having 10 or more pieces of the position tracking data. In this case, in section 1 that is shown in FIG. 3, four cells, that is, (6, 3), (6, 4), (4, 10), and (3, 14) having 15 pieces of data, 13 pieces of data, 13 pieces of data, and 26 pieces of data, respectively, are selected as the main cells. In addition, in an embodiment of the present disclosure, the main cell selector 106 may select the main cells such that the main cells include an origin cell and a destination cell of the moving object.

Once the main cells are selected as described above, the reference route calculator 108 forms a reference route of the moving object by sequentially connecting an origin, the one or more main cells, and a destination of the moving object. Specifically, the reference route calculator 108 may be configured to calculate a partial moving route of the moving object, the partial moving route being one of a plurality of partial moving routes, in a section between two adjacent main cells, the section being one of a plurality of sections between the one or more main cells, and to combine the partial moving routes calculated for each section to form a reference moving route of the moving object.

First, a process of the reference route calculator 108 calculating a partial moving route for each section when the cells have the same size will be described. First, the reference route calculator 108 forms a partial region having a rectangular shape including two adjacent main cells. For example, a rectangular partial region including the cells (6, 4) and (4, 10), which are two adjacent main cells in section 1 that is shown in FIG. 3, is formed as shown in FIG. 4. When the two adjacent cells are positioned in the same row or column, such as the cells (6, 3) and (6, 4), the partial region has a linear shape (i.e. is constituted of a single row or column).

The reference route calculator 108 designates two main cells included in the partial region as an origin cell and a destination cell. Since each of the main cells is on the moving route, there is a time difference between the two main cells. That is, one of the two main cells is an origin cell, and the other is a destination cell. If it is assumed that the moving object moves along the route of FIG. 2 from west to east, the origin cell is the cell (6, 4) and the destination cell is the cell (4, 10) in a partial region of FIG. 4.

Subsequently, the reference route calculator 108 generates one or more moving candidate routes that connect the origin cell and the destination cell in the partial region. In order to limit the number of effective routes between two main cells to an appropriate number in consideration of availability of analysis and calculation, the reference route calculator 108 may set the following conditions with respect to the movement between cells in the partial region.

A first condition is that the movement between cells is possible only up, down, left, and right, that is, movement in a diagonal direction is not considered. A second condition is that a route between two main cells in a reverse temporal direction is not considered. For example, in an embodiment shown in FIG. 4, since a moving object should move from the top leftmost cell to the bottom rightmost cell, the directions of the movement between cells are limited to two directions, that is, up and right. Last, a third condition is that the movement between cells does not depart from a partial region that is formed between two main cells. That is, the moving candidate route is generated by sequentially moving between adjacent cells in the partial region in a direction from the origin cell to the destination cell. When the three conditions are satisfied and a rectangle having n×m cells is formed between two main cells, the total number of moving candidate routes is expressed as Equation 1 below:

$$number of routes = \frac{( n + m - 2 ) !}{( n - 1 ) ! ( m - 1 ) !} . \qquad [ Equation 1 ]$$

In an example shown in FIG. 4, since n=3 and m=7, the number of moving candidate routes is 28 according to Equation 1.

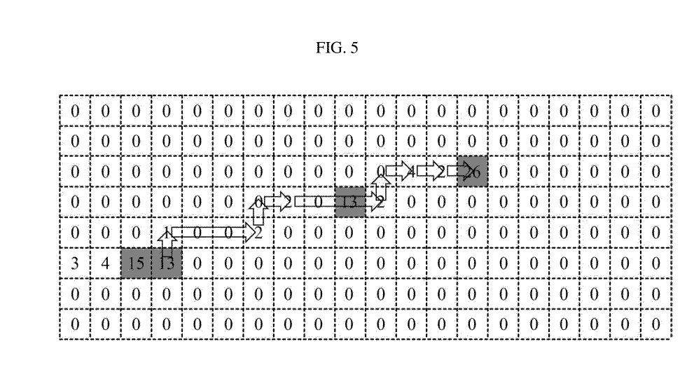

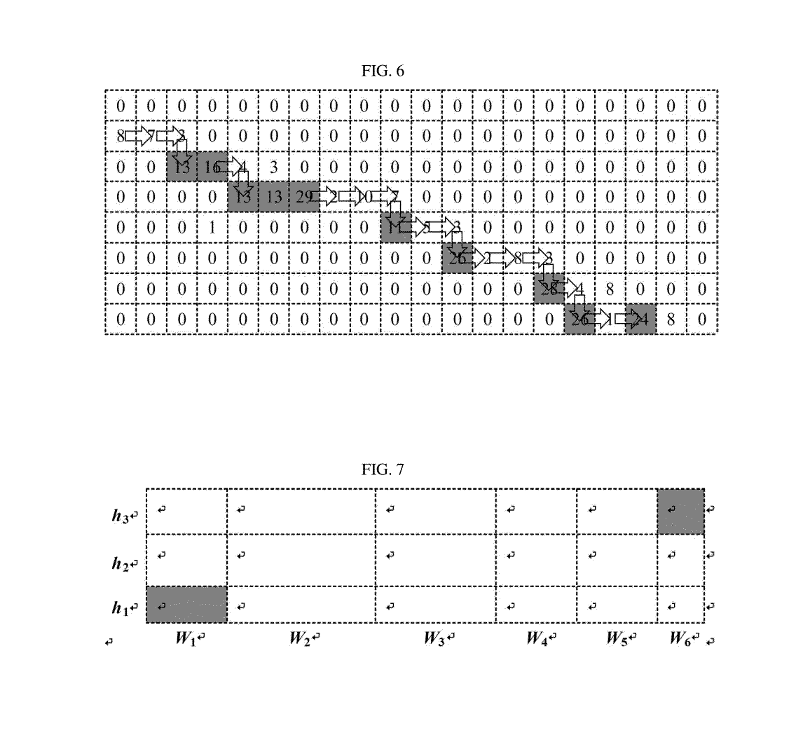

The reference route calculator 108 calculates the number of pieces of the previous position tracking data that are mapped to respective cells on each moving candidate route and selects a moving candidate route having a largest number of pieces of the previous position tracking data as a partial moving route of the moving object between the two adjacent main cells. When there are a plurality of moving candidate routes having the largest number of pieces of the previous position tracking data, the reference route calculator 108 may select any one of the moving candidate routes. As described above, since only right and left movement is assumed in embodiments of the present disclosure, at most two cells may be selected when the moving object moves from one cell to the next cell. Accordingly, each route is one branch of a decision tree from an origin cell. With this, an optimal route between the two main cells may be quickly found. Furthermore, according to an embodiment, some of the three conditions may not be applied. FIGS. 5 and 6 are exemplary diagrams showing reference moving routes in section 1 and section 2 that are generated through the above process.

The reference route calculator 108 may calculate the reference moving route, and a reference moving distance of the moving object when the moving object operates along the reference moving route. Specifically, the reference route calculator 108 may calculate a partial moving distance of the moving object in a section between the two adjacent main cells and add the partial moving distances calculated for each section to calculate a reference moving distance of the moving object.

If the cells in the partial region have the same size, the reference route calculator 108 may calculate the partial moving distance by multiplying a length between the cells by the number of cells included in the partial moving route of the moving object.

On the other hand, if the cells included in the partial region have different sizes, the reference route calculator 108 may calculate the partial moving distance by adding a horizontal length and a vertical length of the partial region. This will be described in more detail below.

It is assumed that the cells in a region in which the moving object moves have sizes that are not uniform but are multiples of each other. In this case, a size of a (k+1)th type of cell has a width nₖ^{(w)} times a width of a k-th type of cell and a height nₖ^{(h)} times a height of the k-th type of cell. In a region including Nₕ×N_{w} cells, k is in a range of 1 to N_{w} in width and is in a range of 1 to Nₕ in height. That is, in a corresponding region, a first-width and first-height cell has a rectangular shape having a width of w₁ and a height of h₁. More generally, a size of a k-th-width and k-th-height cell is expressed as Equation 2 below:

$${w}_{k} = {w}_{1} \times {\prod }_{i = 1}^{k - 1} {n}_{i}^{( w )} , \\ k = 2 , … , {N}_{w} \\ {h}_{k} = {h}_{1} \times {\prod }_{j = 1}^{k - 1} {n}_{j}^{( h )} , \\ k = 2 , … , {N}_{h} . \qquad [ Equation 2 ]$$

As described above, when the cells have the same size, a length of a route may be easily found by counting the number of cells included in the route. However, when the cells have different sizes, it is necessary to calculate a distance between the two main cells in order to calculate the length of the route.

FIG. 7 is an exemplary diagram illustrating a rectangular section that is formed by two main cells when the two cells have different sizes. In this case, two cells, that is, (h₁, w₁) and (h₃, w₆), are assumed as the main cells. A width and a length of each cell may be calculated using Equation 2 above. In this case, a total of 21 candidate routes between the two main cells are calculated using Equation 1, and all of the 21 candidate routes pass through some of cells each having some of w₁ to w₆ and some of h₁ to h₃ only one time. That is, the distance between the two main cells in FIG. 7 may be calculated using Equation 3 below, regardless of what route is selected among the 21 candidate routes:

$$Distance between main cells = {\sum }_{k = 1}^{6} {w}_{k} + {\sum }_{k = 1}^{3} {h}_{k} . \qquad [ Equation 3 ]$$

As a distance between two adjacent main cells is found in the above method, a distance of an entire route may be easily calculated.

Lastly, the reference moving time calculator 110 calculates a reference moving time of the moving object in the reference route using the previous position tracking data. In an embodiment, the reference moving time calculator 110 may calculate a reference moving time of each of the main cells using time information included in the previous position tracking data that is mapped to the respective main cell and calculate a reference moving time of each cell on a moving route that connects the main cells based on the reference moving time of each main cell.

In this case, the reference moving time of each main cell may be any one of an average value and a median value of time information of the previous position tracking data that is mapped to the main cell. The main cell has a predetermined minimum number of pieces of position tracking data or more and is a cell through which a reference line necessarily passes. The position tracking data in the main cell may result from one case or various cases. In addition, the position tracking data includes information on a time taken from an origin in addition to position information. Accordingly, the reference moving time of each main cell may be determined by calculating an average value or a median value of time information of the position tracking data in the main cell.

In addition, the reference moving time of each cell on the moving route that connects the main cells may be calculated by equally dividing a moving time difference between adjacent main cells by the number of cells on a moving route that connects the main cells. For example, when a time difference between two main cells is 8 minutes and an optimal route between the two main cells includes 8 cells, there is a time difference of 1 minute between the cells.

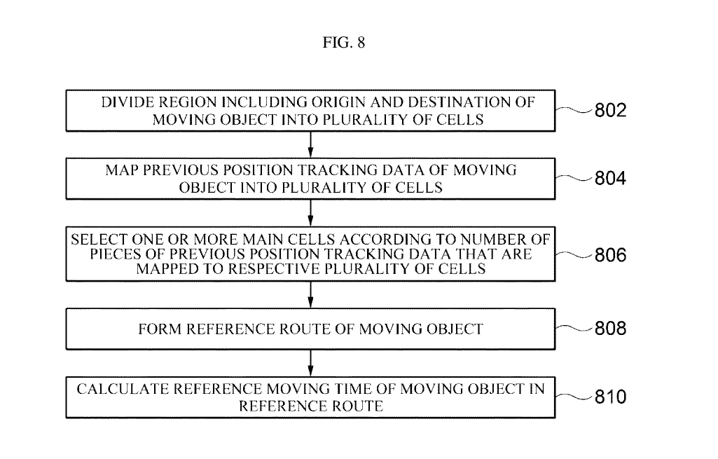

FIG. 8 is a flowchart illustrating a method 800 of calculating a reference route according to an embodiment of the present disclosure.

In operation 802, the region divider 102 divides a region including an origin and a destination of a moving object into a plurality of cells.

In operation 804, the data mapper 104 maps previous location tracking data of the moving object to the plurality of cells.

In operation 806, the main cell selector 106 selects one or more main cells from among the plurality of cells according to the number of pieces of the previous position tracking data that are mapped to the respective plurality of cells.

In operation 808, the reference route calculator 108 forms a reference route of the moving object by sequentially connecting the origin, the one or more main cells, and the destination.

In operation 810, the reference moving time calculator 110 calculates a reference moving time of the moving object in the reference route using the previous position tracking data.

According to embodiments of the present disclosure, it is possible to effectively calculate the reference moving route of the moving object and the reference moving time along the reference moving route using previous position tracking data.

Embodiments of the present disclosure may include a program for performing methods described in this specification on a computer and a non-transitory computer-readable recording medium including the program. The non-transitory computer-readable recording medium may include a program instruction, a local data file, a local data structure, or a combination thereof. The medium may be designed and configured specifically for the present disclosure or can be typically available in the field of computer software. Examples of the computer-readable recording medium include a magnetic medium, such as a hard disk, a floppy disk, and a magnetic tape, an optical recording medium, such as a CD-ROM, a DVD, etc., and a hardware device specially configured to store and perform a program instruction, such as a ROM, a RAM, a flash memory, etc. Examples of the program include a high-level language code executable by a computer with an interpreter, in addition to a machine language code made by a compiler.

Although exemplary embodiments of the disclosure have been described in detail, it will be understood by those skilled in the art that various changes may be made without departing from the spirit or scope of the disclosure. Thus, the scope of the present disclosure is to be determined by the following claims and their equivalents, and shall not be restricted or limited by the foregoing detailed description.

What is claimed is:

1. An apparatus for calculating a reference route of a moving object, the apparatus comprising:
a region divider configured to divide a region comprising an origin and a destination of the moving object into a plurality of cells;
a data mapper configured to map a plurality of pieces of position data of the moving object to the plurality of cells;
a main cell selector configured to select one or more main cells from among the plurality of cells according to numbers of the plurality of pieces of the position data mapped to the respective plurality of cells; and
a reference route calculator configured to form the reference route of the moving object by sequentially connecting the origin, the one or more main cells, and the destination,
wherein the region divider, the data mapper, the main cell selector, and the reference route calculator are implemented via at least one CPU or at least one hardware processor.

2. The apparatus of claim 1, wherein the data mapper selects a position data corresponding to a case in which the moving object arrives at the destination in a preset normal time range, from among the plurality of pieces of position data to map the selected position data to the plurality of cells.

3. The apparatus of claim 1, wherein the main cell selector selects, as the one or more main cells, cells for which a number of pieces of the position data is equal to or greater than a preset reference value.

4. The apparatus of claim 1, wherein when the at least one or more main cells comprises two adjacent main cells, the reference route calculator calculates a partial moving route of the moving object, the partial moving route being one of a plurality of partial moving routes, and being in a section between the two adjacent main cells and combines the partial moving routes calculated for each section to form a reference moving route of the moving object.

5. The apparatus of claim 4, wherein the reference route calculator forms a rectangular partial region including two adjacent main cells, designates the two main cells as an origin cell and a destination cell, generates one or more moving candidate routes connecting the origin cell and the destination cell in the partial region, and determines, as the partial moving route of the moving object between the two adjacent main cells, a moving candidate route having a largest number of the plurality of pieces of the position data among the plurality of pieces of position data.

6. The apparatus of claim 5, wherein the moving candidate route is generated by sequentially moving between adjacent cells in the partial region in a direction from the origin cell to the destination cell.

7. The apparatus of claim 5, wherein the reference route calculator calculates a partial moving distance of the moving object in the section between two adjacent main cells and adds the partial moving distances calculated for each section to calculate a reference moving distance of the moving object.

8. The apparatus of claim 7, wherein the reference route calculator calculates the partial moving distance according to the number of cells included in the partial moving route of the moving object when cells included in the partial region have a same size.

9. The apparatus of claim 7, wherein the reference route calculator calculates the partial moving distance by adding a horizontal length and a vertical length of the partial region when cells included in the partial region have different sizes.

10. The apparatus of claim 1, further comprising a reference moving time calculator configured to calculate a reference moving time of the moving object in the reference route using the plurality of pieces of position data.

11. The apparatus of claim 10, wherein the reference moving time calculator calculates a reference moving time of each main cell of the one or more main cells using time information included in the respective position data that is mapped to each respective main cell of the one or more main cells, and calculates a reference moving time of each cell on a moving route that connects the one or more main cells based on the reference moving time of each of the one or more main cells.

12. The apparatus of claim 11, wherein the reference moving time of each main cell is one of an average value and a median value of time information of the position data that is mapped to each respective main cell.

13. The apparatus of claim 11, wherein the reference moving time of each cell on the moving route that connects the main cells is calculated by equally dividing a moving time difference between adjacent main cells by the number of cells on a moving route that connects the main cells.

14. A method of calculating a reference route of a moving object, the method comprising:
dividing a region including an origin and a destination of the moving object into a plurality of cells;
mapping a plurality of pieces of position data of the moving object to the plurality of cells;
selecting one or more main cells from among the plurality of cells according to numbers of the plurality of pieces of the position data mapped to the respective plurality of cells; and
forming the reference route of the moving object by sequentially connecting the origin, the one or more main cells, and the destination.

15. The method of claim 14, wherein the mapping comprises selecting position data corresponding to a case in which the moving object arrives at the destination in a preset normal time range from among the plurality of pieces of position data to map the selected position data to the plurality of cells.

16. The method of claim 14, wherein the selecting of the one or more main cells comprises selecting, as the one or more main cells, cells for which a number of pieces of the position data is equal to or greater than a preset reference value.

17. The method of claim 14, wherein when the at least one or more main cells comprises two adjacent cells, the forming of the reference route further comprises:
calculating a partial moving route of the moving object, the partial moving route being one of a plurality of partial moving routes, and being in a section between two adjacent main cells; and
combining the partial moving routes calculated for each section to form a reference moving route of the moving object.

18. The method of claim 17, wherein the calculating of the partial moving route of the moving object further comprises:
forming a rectangular partial region including two adjacent main cells and designating the two main cells as an origin cell and a destination cell;
generating one or more moving candidate routes connecting the origin cell and the destination cell in the partial region;
calculating the number of pieces of the position data among the plurality of pieces of position data that are mapped to cells of the plurality of cells included in each of the moving candidate routes; and
determining, as the partial moving route of the moving object between the two adjacent main cells, a moving candidate route having a largest number of the plurality of pieces of the position data.

19. The method of claim 18, wherein the moving candidate route is generated by sequentially moving between adjacent cells in the partial region in a direction from the origin cell to the destination cell.

20. The method of claim 18, wherein the forming of the reference route further comprises:
calculating a partial moving distance of the moving object in the section between the two adjacent main cells; and
adding the partial moving distances calculated for each section to calculate a reference moving distance of the moving object.

21. The method of claim 20, wherein the calculating of the partial moving distance of the moving object comprises calculating the partial moving distance according to the number of cells included in the partial moving route of the moving object when cells included in the partial region have a same size.

22. The method of claim 20, wherein the calculating of the partial moving distance of the moving object comprises calculating the partial moving distance by adding a horizontal length and a vertical length of the partial region when cells included in the partial region have different sizes.

23. The method of claim 14, further comprising, after forming the reference route of the moving object, calculating a reference moving time of the moving object in the reference route using the plurality of pieces of position data.

24. The method of claim 23, wherein the calculating of the reference moving time further comprises:
calculating a reference moving time of each main cell of the one or more main cells using time information included in the respective position data that is mapped to each respective main cell of the one or more main cells; and
calculating a reference moving time for each cell on a moving route that connects the one or more main cells based on the reference moving time of each of the one or more main cells.

25. The method of claim 24, wherein the reference moving time of each main cell is one of an average value and a median value of time information of the position data that is mapped to each respective main cell.

26. The method of claim 24, wherein the reference moving time of each cell on the moving route that connects the main cells is calculated by equally dividing a moving time difference between adjacent main cells by the number of cells on a moving route that connects the main cells.

27. A computer program stored in a non-transitory storage medium and configured to execute the method of claim 14.
